(19) United States
(12) Patent Application Publication
(10) Pub. No.: US 2010/0217679 A1
(43) Pub. Date: Aug. 26, 2010

(54) Ticket trading method

(76) Inventor: Ira Eckstein, Rumson, NJ (US)

Correspondence Address: MALDJIAN & FALLON LLC, 36 BINGHAM AVENUE, RUMSON, NJ, 07760, US

(21) Appl. No.: 12/378,791

(22) Filed: Feb. 20, 2009

(51) Int. Cl. G06Q 30/00; G06Q 40/00; G06Q 20/00; G06Q 90/00

(52) U.S. Cl. 705/26; 705/40; 705/400

(57) ABSTRACT

What is disclosed is a ticket trading method for use at sporting events or other live events. The method relates to recovering the value of an admission ticket if the spectator desires to leave the event early. The method is a computer implemented trading method whereby a spectator would communicate with the computerized system by means of a Blackberry®, or other smart phone, text messenger or by means of a kiosk inside the venue that the ticket was available for resale. The computerized system would broadcast a message to other subscribers to the system that the ticket is available for resale. The subscribers could then purchase the ticket at a predetermined price determined by a trading value model.

### BACKGROUND OF THE INVENTION

The present invention is directed to the field of ticket trading for live events such as sporting events, concerts or other such events. Presently, when tickets are sold and a person enters the event, the end of any transactions occurs. However, people may leave events early for a variety of reasons. If that happens, neither the ticket holder nor the management at the venue of the event can effectively resell the remaining value of the ticket for the remainder of the event, even when the event is otherwise sold out. For example, a ticket holder may leave a baseball game early after five innings and there is currently no method to transfer that person's seat to another person after the event has started. Nor is there any method for the ticket holder to sell the remaining value of the ticket to another person.

The present invention provides a method using available technologies to allow ticket holders and venue management to transfer seat tickets after the event has started. In addition, it allows the ticketholder and/or venue management to recover the value left in the ticket for the remaining time of the event.

### SUMMARY OF THE INVENTION

A method for reselling admission tickets to a live event that has commenced comprising issuing a ticket for admission to the live event to a first spectator for a particular seat at the event; providing a computerized, internet-based system accessible by a communication device for reissuing the admission ticket to a second spectator if the first spectator desires to leave the live event prior to its conclusion wherein the computerized, internet-based system comprises a time value model; receiving a request from the first spectator prior to the end of the live event by means of a communications device to offer the admission ticket to a plurality of potential second spectators; sending a message to the plurality of potential second spectators by the computerized, internet-based system that the admission ticket for the particular seat is available to be reissued for a price determined by the time value model; receiving a request from one of the plurality of potential second spectators to reissue the admission ticket for the price; and reissuing the admissions ticket to the potential second spectator in exchange for payment of the price for the remainder of the live event.

### DETAILED DESCRIPTION OF THE PRESENT INVENTION

The present invention will now be described in terms of the presently preferred embodiments thereof. Those of ordinary skill in the art will recognize that many obvious changes may be made thereto without departing from the spirit or scope of the present invention.

The present invention is directed to a live event ticket trading method. The trading method is directed to recovering the value in a ticket after the event starts when a ticket holder decides to leave the event prior to the end.

The present invention will be more fully explained in the context of a ticket holder at a baseball game, although the scope of the present invention should not be so limited. The ticket holder will be assumed to be a season ticket holder whose seats are located in a desirable area of the stadium such as near to the home team's dugout. The ticket holder will enter the game at the normal starting time but will leave after the fifth inning and wishes to transfer his or her seat to a person who is located in a less desirable area of the stadium or even a person not yet admitted to the stadium.

The present invention will be comprised of an internet based website 10 that can be accessed via any available device such as a Blackberry® or other smart phones or other wireless devices or wired devices with internet access or text messaging capabilities. The website would be programmed to manage the trading of seat tickets for the events. Those wishing to engage in ticket trading, either as seller or buyer, would pre-register for the service on the website so as to gain access to the trading system. When the season ticket holder wishes to leave early, he or she would send a text message to the internet website 10 that he or she was leaving early and the seat would become available on the website for resale. The internet website 10 would send a message to the stadium venue and other website members at the event that the seat was available and the price at which it was available. The website would have information available relative to the seat location as well as price. The information would also be available at stadium kiosks located in the arena for patrons looking to upgrade their current seating. The kiosks would also be located outside the stadium for patrons looking to enter an event for the remaining time. It is contemplated that the kiosks would be able to accept payment by credit card for the ticket and print out a new ticket for the available seat for the remaining time of the event. The revenue from the resale could be directed to the season ticket holders, the stadium management, or be split between the two in some pre-arranged percentage.

Another aspect of the present invention is that persons interested in upgrading their seat or purchasing the remaining ticket value can also post their interest in doing so on the website. For instance, someone sitting in the upper deck of a stadium may send a message to the website that he or she is interested in upgrading to a seat located on the lower level at a certain price. This feature of the present invention will provide an incentive for the persons seated in the more desirable areas of the stadium to sell the remaining ticket value rather that merely leave.

As an alternative embodiment of the present invention, the entire operation of the method could be controlled by the venue management of the event. Rather than a generally available third-party website, the venue management could control the entire trading operation by means of a license issued as part of any ticket for admission. In this way, any such transaction when a ticket holder leaves early would be made through the venue box office, although it is contemplated that the access for buyers and sellers would still be accommodated through wireless text messaging or similar means. In this way, the venue management would control resale prices for the event as well as directly controlling revenue from the re-sales.

Those of ordinary skill will recognize that the present invention can be likewise applied to all live events not just baseball games. The present invention can be applied to all live sporting events including but not limited to basketball, football, hockey and stock car racing. Likewise, the present invention can also have application for concerts or other live events.

In addition to the application of the present invention as described above, it is contemplated that the present invention can be applied in other areas as well. For example, in the grocery store environment, the stores offer perishable items such as meat or dairy products that must be sold by a certain date or discarded. As the last date for sale approaches, the store may wish to discount the price of certain items to encourage sales by the last sale date. The present invention can be applied to facilitate sales of the items. As the last sale date approaches, the store could post the items and then discount the prices. Members of the website would receive messages concerning discounted prices on certain items and proceed to the store to purchase any desired items.

All of the above referenced uses of the present invention can be further implemented by use of a time value model. The purpose of the “Time Value Model” would be to determine what a product would be worth factoring in time and intrinsic value, demand and market volatility. For example, a person decides to leave a basketball game early and wants to sell the ticket. The ticket is released to the venue the resale. The resale value will be determined by taking into account a number of variables including but not limited to how much time is left in the game, the demand for that ticket based on how close the score of the game is or if the teams are elite teams. The “Time Value Model” will determine what that ticket is worth from the exact moment at which it is released. Another example would be milk or another perishable food item offered for sale at a grocery store that will expire and can no longer be offered for sale the next day. The “Time Value Model” would determine the value of that perishable item each day leading up to its expiration. This same model can be used in a hardware or home supply store . . . . For example it can be used for lawn mowers or grass seed at the end of a season. The model would be a computer program that follows volatility for specific items (those listed here and many more). It would take into consideration time, interest rate, demand and volatility and then determine the monetary value for each item.

Another application of the inventor will be in the context of hotel rooms. A typical hotel way to have rooms available for $200.00 at 6:00 p.m. The Time Value Model determines what that room is worth at 7:00 p.m., 8:00 p.m. and 9:00 p.m. etc. if it is still vacant at those times. The following are facts that would determine price:

1. Time of year;

2. week night or weekend;

3. Determine how many rooms are vacant in the area;

4. Events in a given city;

5. Advertising.

The posts would be part of the web based on the Central Location System which users would log onto and use a credit card to “Get It”, which would be an Icon on the screen through PDA Blackberry®, etc., monies or transferred through Pay Pal™, Express Pay™, etc.

Another example of the application of the present invention would be lawn mowers offered for sale at a major hardware chain. For this example, it is assured that the price of a mower at the start of the selling season is $250.00. The Price Model determines what that lawn mower is worth on July 1^{st}. Factors to consider:

1. How many new where sold;

2. Competition;

3. Rain in the Season;

4. General demand in the Economy.

As the season progresses, the mowers will go down in value as demand depends later in the summer and effectively depreciates on the shelf. The Time Value Model would come up with the value. The new price can be updated daily with Led Screens on items are placed in certain sections for faster sales. The price can be lowered by a central system at corporate headquarters or at the local store.

In conclusion, The Hotel Site may have a browser that updates prices every minute or seconds that post a certain time or a consumer posts a bid on the room under where the motel says its worth as time passes the bid might get it by system as price meets bid.

Those of ordinary skill in the art will recognize that the foregoing merely sets forth various embodiments of the present invention and that many obvious modifications may be made thereto without departing from the spirit or scope of the resent invention as set forth in the appended claims.

1. A network-based method for reselling admission tickets to a live event that has commenced inside a venue comprising:
(a) Providing a first spectator, holding a ticket for admission to the live event for a particular seat at the event, which the first spectator purchased at an initial price, access to a computerized, internet-based system via the network;
(b) Providing the computerized, internet-based system, accessible by the first spectator using a communication device, comprising executable instructions for enabling the first spectator to reissue the admission ticket to a second spectator who is a registered user of the network, at a new price, wherein the executable instructions comprise a time value model for determining the new price, the time value model considering the time remaining at the event, an intrinsic value to the first spectator, and a demand and volatility of users of the network;
(c) Allowing the first spectator to provide a request, prior to the end of the live event by means of a communications device to offer the admission ticket to a plurality of potential second spectators through the computerized, internet based system;
(d) Notifying the plurality of potential second spectators of the request made by the first spectator;
(e) Receiving a second request from one of the plurality of potential second spectators to reissue the admission ticket for the new price; and
(f) Selling the ticket to the potential second spectator, in exchange for payment of the new price, for access to the particular seat at the event, for the remainder of the live event.

2. The method of claim 1 whereby the communication device can be either an email-enabled smart phone, a text message capable device, or a fixed kiosk.

3. The method of claim 1 wherein the time value model further considers the desirability of the seat location and the original admission price, for determining the new price.

4. The method of claim 1, further comprising:
receiving requests for seats from a plurality of second spectators who are registered users of the system and transmitting those requests to a plurality of first spectators already admitted to the event.

5. (canceled)

6. The method of claim 1, wherein the live event comprises a live sporting event.

7. The method of claim of 6, wherein the live sporting event comprises one of a baseball, basketball, football, hockey or stock car racing event.

8. The method of claim 1, wherein payment of the new price occurs via a credit card transaction.

9. The method of claim 1, wherein the request of the first spectator comprises one of a SMS, electronic mail or text message.

10. A method for providing financial return to a ticket holder through the reselling of an admission ticket to a particular seat for a live event that has already commenced at a venue, for a remaining period of the live event, consisting of:
allowing a ticket holder, the ticket being for admission to a particular seat at the live event, access a system via a global-computer network using a mobile communication device, when the ticket holder is inside the venue, the system comprising executable instructions for receiving a first request from the ticket holder to post an offer for sale for the admission ticket for the remainder period of the live event;
receiving the first request from the ticket holder;
processing the first request from the ticket holder and transmitting a notice of the offer for sale to a plurality of potential purchasers, wherein the offer for sale comprises a seat location associated with the ticket and a price for the ticket;
receiving a second request from one of the plurality of potential purchasers, the second request comprising an acceptance to the offer for sale and a form of payment of the price for the ticket; and
facilitating the transfer of the ticket to the one of the plurality of potential purchasers, and the payment of the price of the ticket to the ticket holder;
wherein the price of the ticket is determined using a time value model, the time value model consisting essentially of an algorithm factoring in the time remaining at the event, an intrinsic value to the first spectator, and a demand and volatility of users of the system.

11. The method of claim 10, wherein the mobile communication device comprises one of an email-enabled smart phone, a text message capable device, or a kiosk.

12. The method of claim 10, wherein the algorithm of the time value model further considers the desirability of the seat location and the original admission price.

13. The method of claim 10, wherein the ticket holder and the plurality of potential purchasers are pre-registered to the system, prior to the start of the live event.

14. The method of claim 10, wherein the live event comprises a live sporting event.

15. The method of claim of 14, wherein the live sporting event comprises one of a baseball, basketball, football, hockey or stock car racing event.

16. The method of claim 10, wherein the form of payment of the price for the ticket occurs via a credit card transaction.

17. The method of claim 10, wherein the first request of the ticket holder is transmitted via one of a SMS, electronic mail or text message.

18. A method for providing financial return to a ticket holder through the reselling of an admission ticket to a particular seat for a live event that has already commenced at a venue, for a remaining period of the live event, consisting of:
allowing a ticket holder to access a system via a global-computer network using one of an email-enabled smart phone, a text message capable device, or a kiosk, when the ticket holder is inside the venue, the system comprising executable instructions for receiving a first request from the ticket holder to post an offer for sale for the admission ticket for the remainder period of the live event, and the ticket holder being pre-registered with the system prior to the start of the event;
receiving the first request from the ticket holder;
processing the first request from the ticket holder and transmitting a notice of the offer for sale to a plurality of potential purchasers, each of the plurality of potential purchasers having pre-registered with the system prior to the start of the event, wherein the offer for sale comprises a seat location associated with the ticket and a price for the ticket;
receiving a second request from one of the plurality of potential purchasers, the second request comprising an acceptance to the offer for sale and a form of payment of the price for the ticket; and
facilitating the transfer of the ticket to the one of the plurality of potential purchasers, and the payment of the price of the ticket to the ticket holder;
wherein the price of the ticket is determined using a time value model, the time value model consisting essentially of an algorithm factoring in the time remaining at the event, an intrinsic value to the first spectator, a demand and volatility of users of the system, desirability of the seat location and the original admission price.

19. The method of claim 18, wherein the form of payment of the price for the ticket occurs via a credit card transaction.

20. The method of claim 18, wherein the live event comprises a live sporting event.

21. The method of claim of 20, wherein the live sporting event comprises one of a baseball, basketball, football, hockey or stock car racing event.
